(19) United States
(12) Patent Application Publication
(10) Pub. No.: US 2011/0029803 A1
(43) Pub. Date: Feb. 3, 2011

(54) CLOCK RECOVERY OF SERIAL DATA SIGNAL

(75) Inventor: William Redman-White, Hampshire (GB)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/935,917

(22) PCT Filed: Apr. 2, 2009
(86) PCT No.: PCT/IB2009/051387

§ 371 Date: Oct. 1, 2010

(30) Foreign Application Priority Data
Apr. 4, 2008 (GB) 0806157.4

(51) Int. Cl. G06F 1/04

(52) U.S. Cl. 713/502

(57) ABSTRACT

A method and a receiver for recovering clock timing information from a serial data signal by determining data symbol transition times. The method comprises determining data symbol transition times of the serial data according to a first determination scheme, and further data symbol transition times of the serial data according to a second determination scheme. The transition times are then combined by a voting process, wherein the first determination scheme votes for the transition times that it determined, and wherein the second determination scheme votes for the transition times that it determined. The actual transition times are then determined as being the times that have the most votes.

This invention relates to a method and a receiver for recovering clock signalling information from a serial data signal.

Serial data transmission schemes are commonly used for sending large volumes of data at a high speed. Examples of such transmission schemes are the Serial Advanced Technology Attachment (SATA) for interfacing to hard disk drives, and the Peripheral Component Interconnect Express (PCI-X) scheme for interfacing to various computer cards (for example a graphics card). An example of a PCI-X data transmission scheme is described in WO2005/091155.

These types of transmission scheme typically use a pair of conductors to send and receive a voltage signal representing data symbols. The receiver receives the voltage signal, and determines the times at which the voltage signal transitions between different data symbols. Once these transition times are determined, a clock signal can be recovered by using a timing recovery system, for example a phase locked loop, as is well known to those skilled in the art.

The phase accuracy of the recovered clock signal is very important, as it determines the times at which the receiver samples the voltage signal to read the data symbol. Ideally, the voltage signal should be sampled half way through the duration of each data symbol. However, if the phase of the recovered clock signal is not properly aligned with the data symbol transitions, then the receiver will sample the voltage signal at times that are too close to the data symbol transitions, which can lead to errors in the data output. Such errors typically occur due to noise interference or voltage offsets in the receiver. Therefore, it is important that the transition times of the data symbols are accurately determined, so that the recovered clock signal is properly aligned with the data symbols.

A known technique for determining the times at which transitions in the data symbols occur, is to sample the voltage signal several times during each clock cycle. Then, the times at which the data symbol transitions occur can be accurately determined. The ratio between the frequency of the samples and the frequency of the data symbols is commonly referred to as the over-sampling ratio.

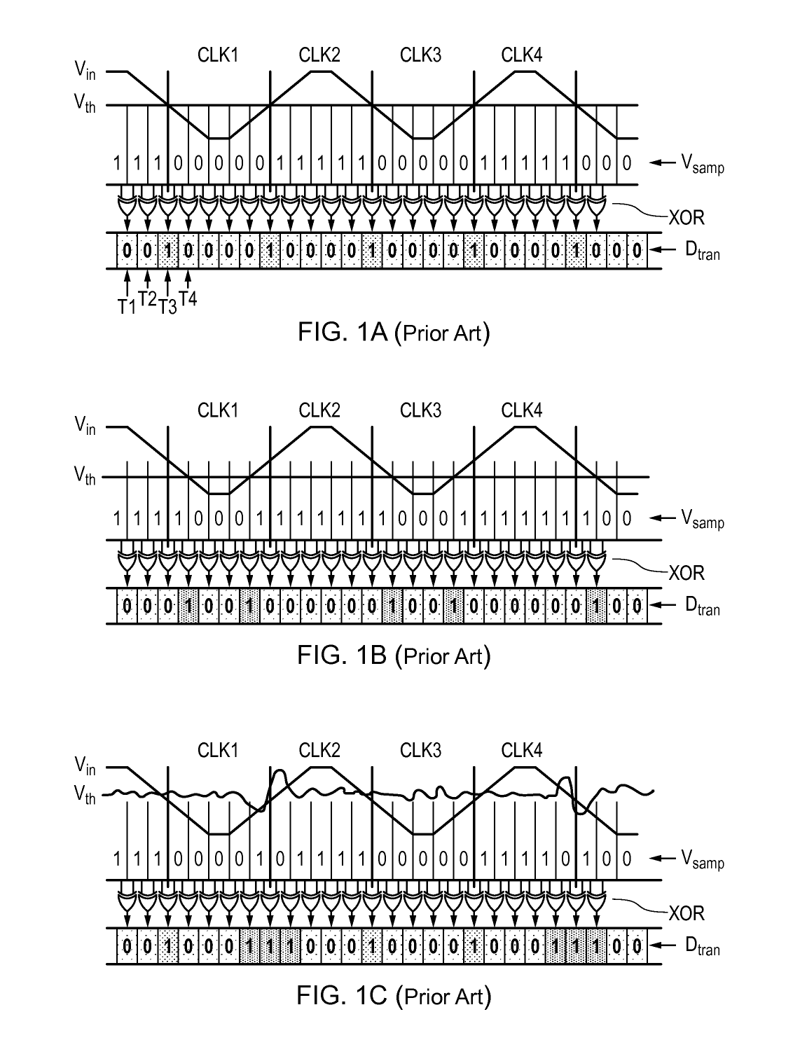

FIG. 1A shows the determination of the transition times of a voltage signal Vᵢₙ, which has data symbols of either logic ‘0’ or logic ‘1’ during four clock cycles CLK1-CLK4. The voltage signal Vᵢₙ is sampled five times every clock cycle, and so there is an over-sampling ratio of five. Each sample Vₛₐₘₚ is judged as a data symbol of logic 0 if it is below the voltage threshold Vₜₕ, or a data symbol of logic 1 if it is above the voltage threshold Vₜₕ. Then, adjacent samples are input to an Exclusive OR (XOR) gate, which outputs data Dₜᵣₐₙ having logic 1's at the times when the data symbol transitions are detected. These logic 1's are used to generate the recovered clock signal, for example by using a phase locked loop, or other means, as will be apparent to those skilled in the art.

There are multiple XOR gates shown in FIG. 1A to demonstrate how the data Dₜᵣₐₙ is generated from the data Vₛₐₘₚ over time. In actual fact, there is only a single XOR gate, and this operates on Vₛₐₘₚ samples 1 and 1 to give Dₜᵣₐₙ output 0 in a first timeslot T1, on Vₛₐₘₚ samples 1 and 1 to give Dₜᵣₐₙ output 0 in a second timeslot T2, on Vₛₐₘₚ samples 1 and 0 to give Dₜᵣₐₙ output 1 in a third timeslot T3, on Vₛₐₘₚ samples 0 and 0 to give Dₜᵣₐₙ output 0 in a fourth timeslot T4, and so on.

However, the determination of these transition times is prone to errors due to noise interference and jitter of the data signal and receiver voltage offsets. Such offsets can occur randomly due to mismatches between the very small transistors typically used in high bandwidth circuits. FIG. 1B shows the effect of a receiver offset voltage, which means the voltage threshold Vₜₕ appears at a lower voltage than is ideal. The result is that the transition times (logic 1's) output from the XOR gate occur at un-even intervals, causing phase errors in the recovered clock signal. FIG. 1C shows the effect of noise interference, which means that the effective voltage threshold Vₜₕ randomly varies with time. The result of a varying voltage threshold is that the XOR gate may output multiple logic 1's for a single transition, leading to ambiguity in the time when the transition actually occurred, and ultimately to phase errors in the recovered clock signal.

Known circuits for accurately determining data symbol transition times and for correcting errors due to noise interference and voltage offsets are often very large or complex, and have varying degrees of effectiveness.

US 2004/120426 discloses a data recovery circuit in which multiple slicer outputs of incoming data for each data bit are processed in a manner that reduces the bit-error rate. One or more slicer outputs are taken at or near the centre of the eye and one or more slicer outputs are taken at or near the leading edge and/or trailing edge of the eye.

Therefore, the invention aims to improve on prior art methods of determining data symbol transition times.

According to a first aspect of the invention, there is provided a method for determining data symbol transition times from a serial data signal, comprising determining data symbol transitions according to a first determination scheme, determining data symbol transitions according to a second determination scheme, and combining the results of the first and second determination schemes according to a voting process to determine the data symbol transition times.

The present invention recognises that different schemes for determining data symbol transition times have different characteristics in terms of how well they perform under varying levels of noise and voltage offsets. Therefore, the invention proposes that a first scheme (for example, the scheme discussed in above in relation to FIGS. 1A-1C) could be combined with a second scheme, which will have different characteristics to the first scheme, such that the combination of the two schemes by a voting process results in a more accurate determination of transition times over a wider range of noise and voltage offsets than could be achieved by either scheme individually.

In both the first and second determination schemes the data symbol transitions may be determined without prior determination of expected symbol edges or centres.

The voting process can comprise the first determination scheme voting for the transition times that it determines, and the second determination process voting for the transition times that it determines, such that the transition times that have the most votes are determined as being the correct transition times.

The first scheme may be more suited to giving precise transition times, but require low noise and low voltage offset, and the second scheme may be more suited to operating under high noise and voltage offsets, but give less precise transition times as a result. Hence, the combination of these first and second schemes by a voting process can give good performance over a wide range of noise and voltage offset levels.

The voting process may make use of the knowledge that the clock frequency of the received serial data should be substantially constant, and that the transitions should therefore occur at regular times. Hence, the voting process may comprise adding together the number of votes for each transition time over a plurality of clock cycles, to give a more accurate determination of when the transitions occur.

According to a second aspect of the invention, there is provided a receiver for receiving a serial data signal and determining data symbol transition times of the data signal, comprising:
a first determination means for determining data symbol transitions according to a first determination scheme;
a second determination means for determining data symbol transitions according to a second determination scheme; and
a voting process means for combining the results of the first and second determination schemes according to a voting process to determine the data symbol transition times.

The receiver comprises first and second determination means, and a voting process means. These means can be implemented as circuitry within an integrated circuit, although many other ways of implementing a receiver will also be apparent to those skilled in the art, such as by using discrete components, or by executing computer program code on a processor.

A further aspect of the invention provides an integrated circuit incorporating the receiver of the first aspect.

Examples of the invention will now be described with reference to the accompanying drawings, in which:

FIGS. 1A-C show the determination of transition times according to a known method;

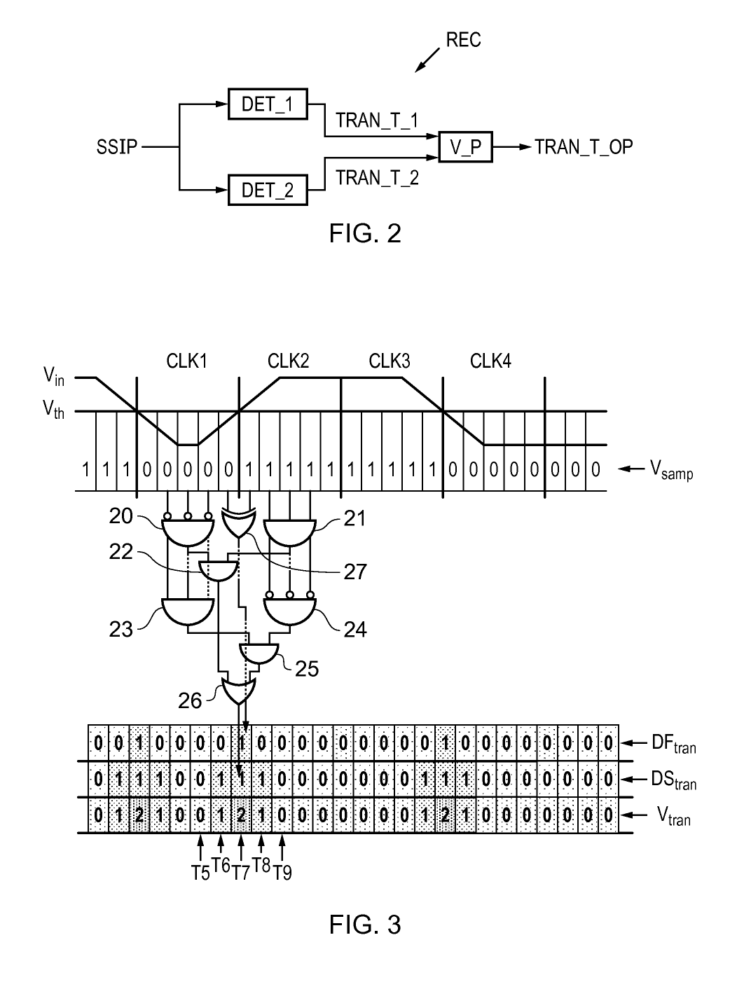

FIG. 2 shows a block diagram of a receiver according to an example of the invention;

FIG. 3 shows the determination of transition times according to first and second determination schemes and a voting process according to another example of the invention;

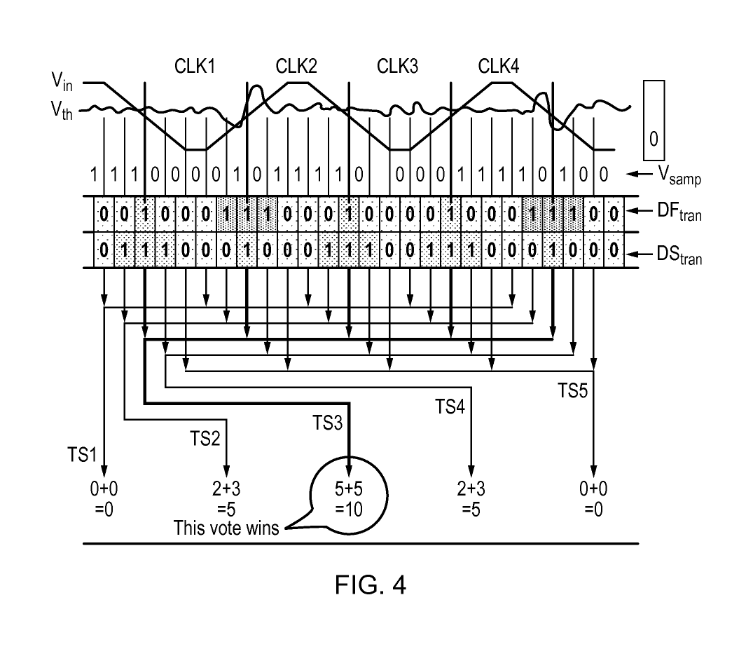

FIG. 4 shows the determination of transition times according to the first and second determination schemes of FIG. 3, and according to a voting process that adds votes over multiple data symbol periods under electrically noisy conditions or in the presence of jitter;

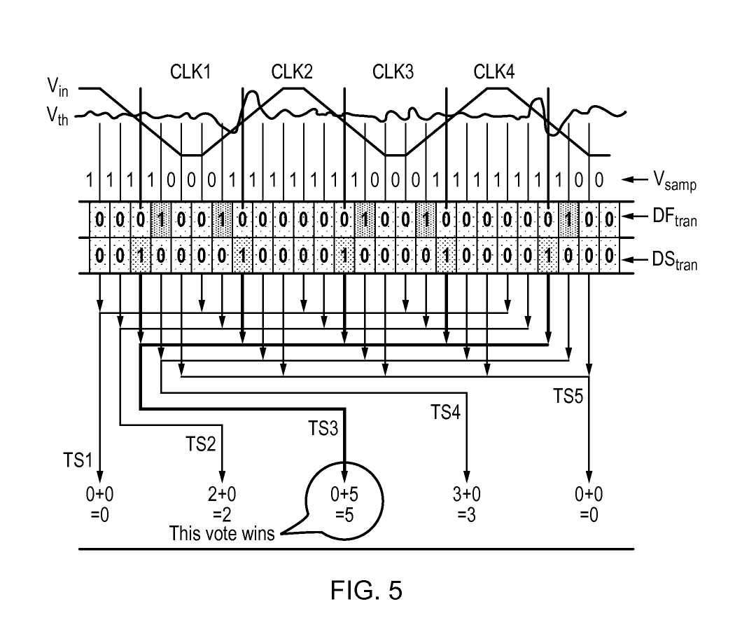

FIG. 5 shows the determination of transition times according to the first and second determination schemes of FIG. 3, and according to a voting process that adds votes over multiple data symbol periods under electrically offset conditions;

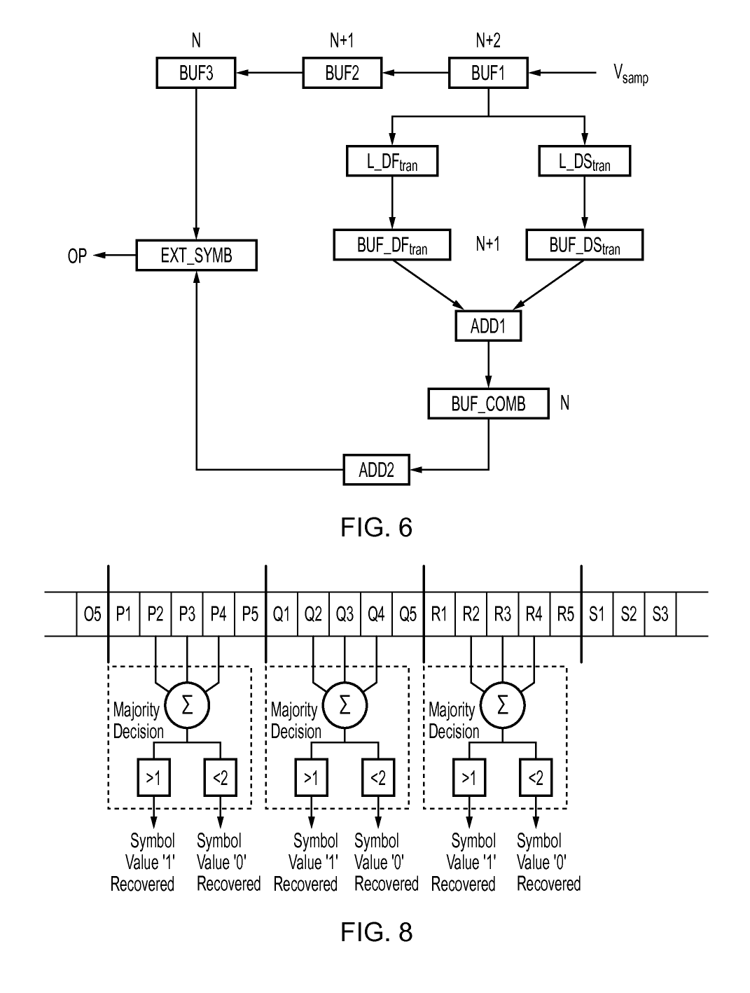

FIG. 6 shows a diagram of a system for determining transition times according to a further example of the invention;

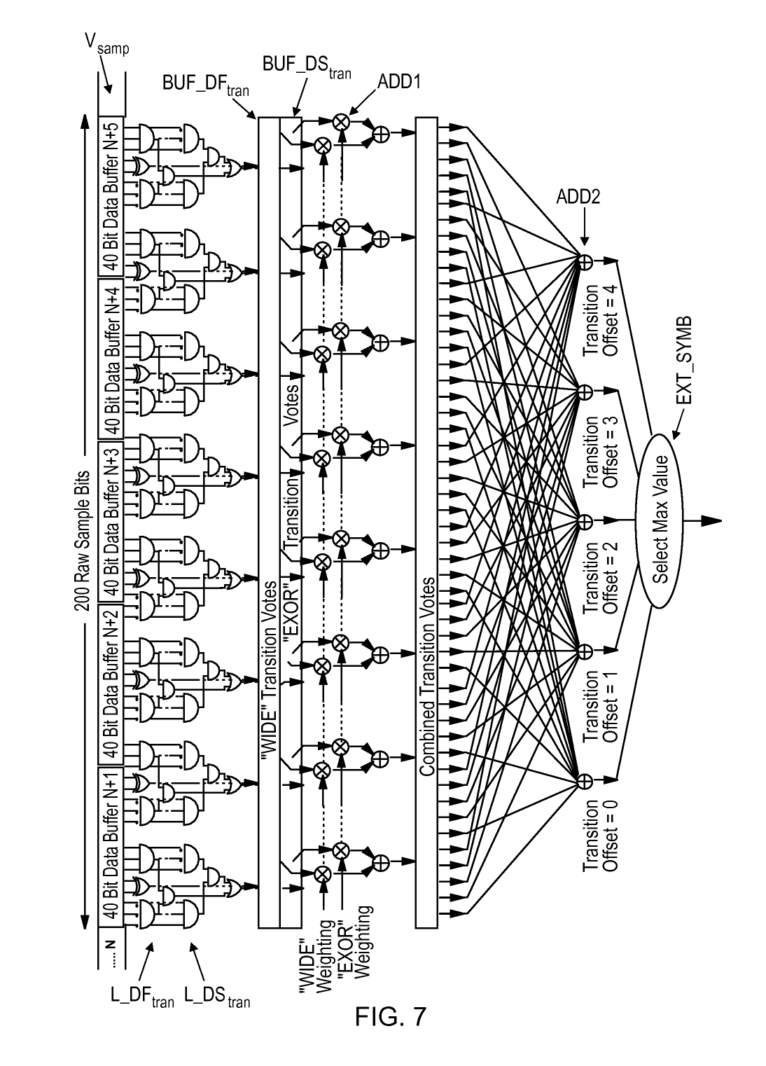

FIG. 7 shows a conceptual diagram of the processing performed by the system of FIG. 6; and

FIG. 8 shows the extraction of data symbol values according to the system of FIG. 6.

Same or similar reference signs denote same or similar features.

The block diagram of FIG. 2 shows the determination of transition times TRAN_T_OP in a receiver REC according to an example of the invention. Firstly, the serial data signal SSIP is input to both a first data symbol transition determination scheme DET_1 and a second data symbol transition determination scheme DET_2. The first determination scheme DET_1 determines data symbol transition times TRAN_T_1, and the second determination scheme DET_2 determines data symbol transition times TRAN_T_2. The transition times TRAN_T_1 and TRAN_T_2 are passed to a voting process V_P, which combines the transition times TRAN_T_1 and TRAN_T_2 to generate the output transition times TRAN_T_OP. These transition times TRAN_T_OP may be used to indicate the times at which the data symbols of the serial data signal SSIP should be measured. The first determination scheme DET1 is implemented by a first determination means, the second determination scheme DET2 is implemented by a second determination means, and the voting process V_P is implemented by a voting process means. These means may be implemented as circuits within an integrated circuit, as will be apparent to those skilled in the art. In an extended example, a sampling means is added to the receiver to sample the serial data signal SSIP before it is passed to the determination means DET_1 and DET_2, in order to aid the processing of the serial data signal. The sampling means may sample the serial data signal by determining the data symbol to which the sample corresponds.

The implementation of examples of first and second determination schemes will now be described with reference to FIG. 3. The received voltage signal Vᵢₙ is compared to a voltage threshold Vₜₕ in order to extract the data Vₛₐₘₚ that corresponds to data symbols of logic 1 and logic 0, in a similar manner to that described in relation to FIG. 1A above. The voltage signal Vᵢₙ could be a differential voltage signal between two signal lines, and so comparing the signal Vᵢₙ to a threshold voltage Vₜₕ may mean testing the differential voltage signal for its sign (i.e. testing for whether the differential signal is positive or negative) in order to generate the data Vₛₐₘₚ, as will be apparent to those skilled in the art.

As shown on FIG. 3, the voltage signal Vᵢₙ represents data symbols of logic 0 during clock cycles CLK 1 and CLK 4, and logic 1 during clock cycles CLK 2 and CLK 3. Clearly, there is no data symbol transition between clock cycles CLK 2 and CLK3, although the occasional absence of transitions, as is normal in a data signal, will not significantly degrade the phase accuracy of the clock signal recovered by the Phase Locked Loop or other timing recovery circuitry. Signal transmission protocols often define a maximum number of common data symbols that are allowed to be transmitted sequentially, to provide a minimum number (run length) of data symbol transitions that the receiver can expect to receive within a given number of data symbols, as will be apparent to those skilled in the art.

The first determination scheme, in this example, is implemented by an XOR gate 27. The XOR gate 27 receives time adjacent samples of data Vₛₐₘₚ in order to generate output data DFₜᵣₐₙ, in a similar manner to the XOR gate of FIG. 1A. The output data DFₜᵣₐₙ comprises logic 1's at the times when the XOR gate 27 determines the occurrence of a transition in the data symbol represented by the voltage Vin. The first determination scheme determines the precise times at which the input voltage Vᵢₙ transitions between different data symbols, however, the scheme is susceptible to errors due to jitter or due to noise interference of the voltage signal Vᵢₙ and receiver voltage offsets in the threshold voltage Vₜₕ.

The second determination scheme, in this example, is implemented by six AND gates 20-25 and OR gate 26 which operate on the data Vₛₐₘₚ to give output data DSₜᵣₐₙ. The AND gates 20 and 24 have inverting inputs, such that they output a logic 1 only when all of their inputs are logic 0. The AND gate 22 outputs a logic 1 whenever a sequence of three logic 0's is followed by a sequence of three logic 1's that occur two samples later than the three logic 0's. The AND gate 25 outputs a logic 1 whenever a sequence of three logic 1's is followed by a sequence of three logic 0's that occur two samples later than the three logic 1's. The outputs of AND gates 22 and 25 are then combined in the OR gate 26, which will output a logic 1 in the output data DSₜᵣₐₙ when a sequence of three common logic values is followed by a sequence of three common logic values of the opposite polarity. The six AND gates 20-25 and OR gate 26 effectively implement a sliding window function that determines the rough (but not the exact) times of the transitions in the data symbols. For example, within timeslot T5, the AND gates 20 and 23 receive inputs ‘100 ’ and the AND gates 21 and 24 receive inputs ‘011 ’, giving a DSₜᵣₐₙ output of 0. Within timeslots T6-T8, the AND gates 20 and 23 receive inputs ‘000 ’ and the AND gates 21 and 24 receive inputs ‘111 ’, giving a DSₜᵣₐₙ output of 1. Within timeslot T9, the AND gates 20 and 23 receive inputs ‘001 ’ and the AND gates 21 and 24 receive inputs ‘111 ’, giving a DSₜᵣₐₙ output of 0. Hence, the output DSₜᵣₐₙ indicates that the transition occurs somewhere within timeslots T6-T8.

This second determination scheme in this example is resistant to noise interference and voltage offsets, because it looks for the data symbols themselves (a sequence of three common data samples), rather than for a transition between one data sample and the next.

In this example, the over-sampling ratio between the data sampling rate and the incoming data symbols is five, and the second determination scheme in this example looks for a sequence of three common data samples in order to establish the presence of a data symbol (i.e. if the first and last data samples of a data symbol are corrupted due to noise or interference, then there are three common data samples between the first and last data samples, which can be detected). Clearly, the over-sampling ratio of five could also be used with a second determination scheme that detected a sequence of two common data samples, or a sequence of four common data samples. If a different over-sampling ratio is used, for example a ratio of ten, then the second determination scheme may be modified to detect different sequence lengths of common data samples, for example sequence lengths of four to eight common data samples.

Next, the output data DFₜᵣₐₙ and DSₜᵣₐₙ of the first and second determination schemes are combined in a voting process that outputs data Vₜᵣₐₙ. The output data Vₜᵣₐₙ indicates the timeslots at which the transitions occur according to the combination of the first and second determination schemes. For example, at timeslot T6 the DFₜᵣₐₙ output gives a vote of 0 and the DSₜᵣₐₙ output gives a vote of 1, giving a total of 1 vote for a transition within timeslot T6. At timeslot T7 the DFₜᵣₐₙ output gives a vote of 1 and the DSₜᵣₐₙ output gives a vote of 1, giving a total of 2 votes for a transition within timeslot T7. At timeslot T8, the DFₜᵣₐₙ output gives a vote of 0 and the DSₜᵣₐₙ output gives a vote of 1, giving a total of 1 vote for a transition within timeslot T8. Hence, the transition time is determined to be within timeslot T7 because this timeslot has the most overall votes from the first and second determination schemes. The output data Vₜᵣₐₙ gives more accurate transition times then either of the output data DFₜᵣₐₙ or DSₜᵣₐₙ in isolation. For example, FIG. 4 shows a diagram of Vₛₐₘₚ, DFₜᵣₐₙ, and DSₜᵣₐₙ when generated using the same first and second determination methods as described in relation to FIG. 3. As can be seen from FIG. 4, when the input signal Vᵢₙ has significant noise interference (which is shown on the diagram as noise in the voltage threshold Vₜₕ), neither the output data DFₜᵣₐₙ or DSₜᵣₐₙ consistently give transition times that are accurate to within a single timeslot. However, if the output data DFₜᵣₐₙ and DSₜᵣₐₙ are added together in a voting process as described in relation to FIG. 3, then the resulting output indicates transition times (for timeslots that have two votes) that are accurate to a single timeslot.

Clearly, a similar voting process could be used to combine the results of more than two determination schemes together.

For simplicity, the voltage signal Vᵢₙ in this example encodes two data symbols of logic 0 and logic 1, although in other examples the voltage signal Vin may encode more than two data symbols, such as 4 data symbols.

A further voting process will now be described with reference to FIG. 4 and FIG. 5. The same first and second determination schemes as described in relation to FIG. 3 are used to generate the output data DFₜᵣₐₙ and DSₜᵣₐₙ of FIG. 4 and FIG. 5.

The input signal Vᵢₙ is sampled at a rate that is, in this example, five times higher than the clock signal frequency (an over-sampling ratio of five), such that there are five timeslots for each data symbol.

The timeslots are numbered in a repeating sequence of TS1-TS5, and therefore all the data symbol transitions occurring within a time spanning multiple clock cycles can be expected to occur within in one of these five timeslot numbers TS1-TS5. This is exploited in the further voting process, which adds up votes from the output data DFₜᵣₐₙ and DSₜᵣₐₙ over multiple clock cycles, in order to determine within which timeslots TS1-TS5 the data symbol transitions occur.

As can be seen in FIG. 4, there are 0 votes in DFₜᵣₐₙ and DSₜᵣₐₙ for timeslot TS1, 2 votes in DFₜᵣₐₙ and 3 votes in DSₜᵣₐₙ giving a total of 5 votes for for timeslot TS2, 5 votes in DFₜᵣₐₙ and 5 votes in DSₜᵣₐₙ giving a total of 10 votes for timeslot TS3, 2 votes in DFₜᵣₐₙ and 3 votes in DSₜᵣₐₙ giving a total of 5 votes for timeslot TS4, and 0 votes in DFₜᵣₐₙ and DS timeslot lot TS5. Hence, timeslot TS3 has the most votes, and is therefore determined as the timeslot in which the data symbol transitions occur.

FIG. 5 shows the further voting process when applied to a system in which the threshold voltage Vₜₕ has been offset due to a voltage offset in the receiver, for example an offset in the system used to compare the levels of each signal line when a differential signal is used. The data outputs DFₜᵣₐₙ and DSₜᵣₐₙ are determined using the first and second determination schemes described in relation to FIG. 3, and the further voting process is the same as described in relation to FIG. 4 above. As can be seen on FIG. 5, the further voting process correctly determines that the data symbol transitions occur in timeslot TS3, since timeslot TS3 receives the highest number of votes from the data outputs DFₜᵣₐₙ and DSₜᵣₐₙ.

Information on which timeslot the further voting process determines as the timeslot in which data symbol transitions occur (TS3 in the examples of FIG. 4 and FIG. 5), can be used by a Phase Locked Loop or other timing recovery circuit to lock the phase of the recovered clock signal onto the timeslot, thereby enabling the receiver to sample the voltage signal Vᵢₙ at times in the middle of the data symbols.

Alternatively, an algorithm may be used to identify which timeslots are at the centre of the data symbol periods, based on the timeslots that have been determined as the timeslots in which data symbol transitions occur. Then, the data symbols may be sampled within these identified timeslots. Such an algorithm avoids the settling issues of a true PLL. A system for implementing one of many such possible algorithms will now be described with reference to FIGS. 6 to 8.

The diagram of FIG. 6 shows that the system comprises a first buffer BUF1, a second buffer BUF2, and a third buffer BUF3. Each buffer can store a block of 40 data samples Vₛₐₘₚ of the input signal V. The data samples Vₛₐₘₚ are generated in the same way as described in relation to FIG. 3 above, and so each data sample Vₛₐₘₚ corresponds to a particular timeslot.

The system also comprises 40 logic circuits L_DFₜᵣₐₙ and 40 logic circuits L_DSₜᵣₐₙ that are both connected to the first buffer BUF1. The 40 logic circuits L_DFₜᵣₐₙ are for calculating 40 data outputs DFₜᵣₐₙ from the 40 data samples Vₛₐₘₚ according to a first determination scheme, and the 40 logic circuits L_DSₜᵣₐₙ are for calculating 40 data outputs DSₜᵣₐₙ from the 40 data samples Vₛₐₘₚ according to a second determination scheme. In this example, the first and second determination schemes are the same as those described above in relation to FIG. 3, and so each one of the 40 logic circuits L_DFₜᵣₐₙ is formed of an XOR gate, and each one of the 40 logic circuits L_DSₜᵣₐₙ is formed of six AND gates and an OR gate that are connected in the same manner as shown on FIG. 3.

Whenever a new block of 40 data samples Vₛₐₘₚ is clocked into the buffer BUF1, the 80 logic circuits L_DFₜᵣₐₙ and L_DSₜᵣₐₙ immediately calculate the 80 data outputs DFₜᵣₐₙ and DSₜᵣₐₙ. The system further comprises a buffer BUF_DFₜᵣₐₙ for storing the 40 data outputs DFₜᵣₐₙ and a buffer BUF_DSₜᵣₐₙ for storing the 40 data outputs DSₜᵣₐₙ. The 40 data outputs DFₜᵣₐₙ stored in the buffers BUF_DFₜᵣₐₙ are added to the respective 40 outputs DSₜᵣₐₙ stored in the buffers BUF_DSₜᵣₐₙ by 40 adder circuits ADD1, thereby giving 40 data values Vₜᵣₐₙ. Each data value Vₜᵣₐₙ corresponds to the number of votes from the first and second determination schemes that a transition occurs within a particular timeslot. These 40 combined data values are stored in a buffer BUF_COMB, which has sufficient capacity to store at least five sets of 40 data values Vₜᵣₐₙ. Therefore, the buffer BUF_COMB can store 5*40=200 data values Vₜᵣₐₙ corresponding to 200 timeslots.

In his example, the over-sampling ratio is 5, and so there are 5 timeslots per data symbol. Hence, the timeslots can be numbered in a repeating sequence of TS1-TS5, and the data symbol transitions can be expected to regularly occur within one of the timeslots TS1-TS5, as described above in relation to the further voting process and FIG. 4.

Since the buffer BUF_COMB can store 200 data values Vₜᵣₐₙ, a group of 40 of these correspond to TS1 timeslots, another group of 40 correspond to TS2 timeslots, another group of 40 correspond to TS3 timeslots, another group of 40 correspond to TS4 timeslots, and the final group of 40 correspond to TS5 timeslots.

A set of five adder circuits ADD2 is connected to the buffer BUF_COMB, and each adder circuit adds together one of the groups of 40 data values Vₜᵣₐₙ. For example, the first adder circuit of set ADD2 adds together the group of 40 data values Vₜᵣₐₙ that correspond to the TS1 timeslots, in order to give a total vote taken over the 200 timeslots for the likelihood that the data symbol transitions occur within the timeslots TS1. The other four adder circuits work in the same way for the other four groups of 40 data values Vₜᵣₐₙ that correspond to the four timeslots TS2-TS5.

The block EXT_SYMB receives and compares the five total votes from the five adder circuits ADD2, and the data symbol transitions are determined to occur within which ever of the timeslots TS1-TS5 received the largest total vote. The block EXT_SYMB then extracts the data symbols from the samples Vₛₐₘₚ, by looking at the samples Vₛₐₘₚ of the timeslots that are in between the timeslots TS1-TS5 that received the largest total vote. The extraction of the data samples in this example is performed by adding together the samples Vₛₐₘₚ of the timeslots that are in the middle of the data symbol, and comparing the total to a threshold to determine whether the data symbol is a logic 1 or a logic 0. FIG. 8 shows this in more detail, where the data symbol values of three data symbols P, Q, and R are determined.

The operation of the system will now be described as successive blocks of 40 data samples Vₛₐₘₚ are written into the buffer BUF1. Initially, all the buffers are empty, and then the system is then clocked by a pipeline clock signal that is equal to the over-sampling clock rate divided by the length of the buffers BUF1 to BUF3. This will typically be in the range of 100's of MHz using the technology current at the time of filing.

At the beginning of a first pipeline clock cycle, a block N of 40 data samples is clocked into the first buffer BUF1. Then, the 80 logic circuits L_DFₜᵣₐₙ and L_DSₜᵣₐₙ connected to the first buffer determine the 40 data outputs DFₜᵣₐₙ(N) according to the first determination scheme, and the 40 data outputs DSₜᵣₐₙ (N) according to the second determination scheme.

At the beginning of the second pipeline clock cycle, another block N+1 of another 40 data samples is clocked into the first buffer BUF1, the block of data N is clocked into the second data buffer BUF2, and the 80 data outputs DFₜᵣₐₙ (N) and DSₜᵣₐₙ(N) are stored in the buffers BUF_DFₜᵣₐₙ, and BUF_DSₜᵣₐₙ respectively. Then, the 80 logic circuits connected to the first buffer BUF1 calculate the 40 data outputs DFₜᵣₐₙ(N+1) according to the first determination scheme and the 40 data outputs DSₜᵣₐₙ (N+1) according to the second determination scheme. Simultaneously, the 80 data outputs DFₜᵣₐₙ (N) and DSₜᵣₐₙ(N) that are now stored in the buffers BUF_DFₜᵣₐₙ and BUF_DSₜᵣₐₙ are added together by the 40 adder circuits ADD1 to give 40 data outputs Vₜᵣₐₙ(N), one for each timeslot.

At the beginning of the third pipeline clock cycle, another block N+2 of another 40 data samples is clocked into the first buffer BUF1, the block of data N+1 is clocked into the second data buffer BUF2, the block of data N is clocked into the third data buffer BUF3, the 80 data outputs DFₜᵣₐₙ (N+1) and DSₜᵣₐₙ(N+1) are stored in the buffers BUF_DFₜᵣₐₙ and BUF_DSₜᵣₐₙ respectively, and the 40 data outputs Vₜᵣₐₙ(N) are stored in the buffer BUF_COMB. Then, the 80 logic circuits connected to the first buffer determine the 40 data outputs DFₜᵣₐₙ(N+2) according to the first determination scheme and the 40 data outputs DSₜᵣₐₙ(N+2) according to the second determination scheme. Simultaneously, the 80 data outputs DFₜᵣₐₙ(N+1) and DSₜᵣₐₙ(N+1) that are now stored in the buffers BUF_DFₜᵣₐₙ and BUF_DSₜᵣₐₙ respectively are added together by the 40 adder circuits to give another 40 data outputs Vₜᵣₐₙ(N+1). At the same time, the 40 data outputs Vₜᵣₐₙ(N) that are now stored in the buffer BUF_COMB are added by the five adders ADD2 to give five total vote values that are input to the block EXT_SYMB. FIG. 3 shows the positions of the data blocks N, N+1, and N+2 at the end of the third pipeline clock cycle.

At the beginning of the fourth pipeline clock cycle, another block N+3 of another 40 data samples is clocked into the first buffer BUF1, the block of data N+2 is clocked into the second data buffer BUF2, the block of data N+1 is clocked into the third data buffer BUF3, the 80 data outputs DFₜᵣₐₙ (N+2) and DSₜᵣₐₙ(N+2) are stored in the buffers BUF_DFₜᵣₐₙ and BUF_DSₜᵣₐₙ respectively, and the 40 data outputs Vₜᵣₐₙ(N+2) are stored in the buffer BUF_COMB. Additionally, the block EXT_SYMB outputs the data symbols that are extracted from the block of data N.

Then, the 80 logic circuits connected to the first buffer determine the 40 data outputs DFₜᵣₐₙ (N+3) according to the first determination scheme and the 40 data outputs DSₜᵣₐₙ (N+3) according to the second determination scheme. Simultaneously, the 80 data outputs DFₜᵣₐₙ(N+2) and DSₜᵣₐₙ(N+2) that are now stored in the buffers BUF_DFₜᵣₐₙ and BUF_DSₜᵣₐₙ respectively are added together by the 40 adder circuits to give another 40 combined data outputs Vₜᵣₐₙ(N+2). At the same time, the 80 data outputs Vₜᵣₐₙ(N) and Vₜᵣₐₙ(N+1) that are now stored in the buffer BUF_COMB are added by the five adders ADD2 to give another five total vote values that are input to the block EXT_SYMB.

The process continues through subsequent clock cycles. Clearly, improved results will be obtained after the 7^{th} or 8^{th} clock cycle when the buffer BUF_COMB has been filed up with 200 data outputs Vₜᵣₐₙ, because then the voting process effectively adds up votes taken over 200 timeslots instead of a lower number of timeslots.

In this example, the signal transmission protocol sets a maximum run length of five common data symbols that can follow one another sequentially. The over-sampling ratio in this example is five samples per data symbol, and so a data symbol transition can be expected at least once every 25 data samples. Therefore, the buffer length of 200 samples should provide at least 8 data symbol transitions. Clearly, the longer the length of the buffer, the more data symbol transitions that are present. The more data symbols transitions that are present, the more accurately the algorithm can average out the effects of noise and other imperfections, and the more accurate the determination of the timeslot in which transitions occur will be.

A conceptual diagram of how the processing described in FIG. 6 is performed over the full 200 samples is shown in FIG. 7. The system shown in FIG. 6 effectively pipelines the processing that is shown in FIG. 7, and reduces the circuit complexity. The block of data N is sufficiently small in length that the logic undertaking the transition detection is small, but large enough so that it is processed at a rate which is low enough to use conventional logic economically. FIG. 7 shows that the adder circuits ADD1 may additionally comprise a multiplication stage for weighting the data DFₜᵣₐₙ and DSₜᵣₐₙ that is received from the first and second determination schemes. This weighting can be adjusted to give more or less weight to one of the determination schemes in the voting process, enabling better results to be achieved.

In practice, small differences between the frequency of the incoming data symbols and the receiver's reference frequency will over time cause the system to find different ones of the timeslots TS1-TS5 as the timeslots in which data symbol transitions occur. When the frequency differences cause the determined timeslot number to change, for example from TS2 to TS3, some buffer memory at the output may be necessary to accommodate this effect.

In the above embodiments, in both the first and second determination schemes the data symbol transitions are determined without prior determination of expected symbol edges or centres. The determination is performed (as described above) from a stream of samples taken from the incoming signal without prior determination of expected symbol edges or centres. For example, referring to FIG. 3, it will be appreciated that the voting score inputs DFₜᵣₐₙ and DSₜᵣₐₙ are derived automatically from the stream without this derivation referencing any estimated, predetermined or notified indications of where the scores are expected to be higher. This advantageously allows the above described embodiments to be employed where such information is either fundamentally not available or where even if fundamentally allowable, the use of such information is nevertheless undesirable, e.g. for reasons of cost, complexity, inefficiency, time delay etc. This also avoids any requirement for the local clock to be synchronous in frequency and phase to any precision, only sufficiently near in frequency. Also avoided is any requirement to adjust the frequency and phase of the local clock to match the incoming signal. Also there is no requirement to adjust slicing thresholds, i.e. the above embodiments tend to be insensitive to variations in thresholds. However, it will be appreciated that although the above discussed prior determination of expected symbol edges or centres is not required in the above described embodiments, this does not prevent the above described embodiments being employed where such information is available nor does this prevent the above described embodiments being used in some manner in conjunction with such prior determination.

The invention has been described in the context of two specific data symbol transition determination schemes, however those skilled in the art will appreciate that a wide variety of other determination schemes could also be combined using a voting process to combine the advantages of each determination scheme into a single system. For example, there are a wide variety of modifications that could easily be made to the logic circuitry shown in FIG. 3, such as increasing or reducing the number of samples input to the logic gates 20, 21, 23, and 24, or realising similar logic functions using other arrangements of logic gates.

Although the invention has been described in the context of examples that have 5 samples (timeslots) per clock cycle, those skilled in the art will appreciate that other numbers of samples (timeslots) per clock cycle could also be used.

From reading the present disclosure, other variations and modifications will be apparent to the skilled person. Such variations and modifications may involve equivalent and other features which are already known in the art, and which may be used instead of, or in addition to, features already described herein.

In summary, there is provided a method and a receiver for recovering clock timing information from a serial data signal by determining data symbol transition times. The method comprises determining data symbol transition times of the serial data according to a first determination scheme, and further data symbol transition times of the serial data according to a second determination scheme. The transition times are then combined by a voting process, wherein the first determination scheme votes for the transition times that it determined, and wherein the second determination scheme votes for the transition times that it determined. The actual transition times are then determined as being the times that have the most votes.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination.

The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, a single processor or other unit may fulfil the functions of several means recited in the claims and reference signs in the claims shall not be construed as limiting the scope of the claims.

1. A method for determining data symbol transition times from a serial data signal, comprising:
determining data symbol transitions according to a first determination scheme;
determining data symbol transitions according to a second determination scheme; and
combining the results of the first and second determination schemes according to a voting process to determine the data symbol transition times.

2. A method according to claim 1, wherein in both the first and second determination schemes the data symbol transitions are determined without prior determination of one of expected symbol edges and centres.

3. A method according to claim 1, wherein the first determination scheme comprises:
sampling the serial data signal; and
determining that a data symbol transition has occurred when a first sample value corresponds to a different data symbol than a second sample value, the first and second sample values being time adjacent to one another.

4. A method according to claim 1, wherein the second determination scheme comprises:
sampling the serial data signal;
detecting a first series of sample values that all correspond to the same data symbol as one another;
detecting a second series of sample values that all correspond to the same data symbol as one another, the first series of sample values corresponding to a different data symbol than the second series of data samples; and
determining that a data symbol transition has occurred between the first and second series of sample values.

5. A method according to claim 3, wherein the sampling comprises comparing the serial data signal to a voltage threshold, and determining that the sample corresponds to a first data symbol if the voltage signal is above the threshold, and a second data symbol if the voltage signal is below the threshold.

6. A method according to claim 5, wherein the serial data signal is a differential voltage signal.

7. A method according to claim 5, wherein the sampling is performed at a sampling rate that is at least four times the data symbol rate.

8. A method according to claim 1, wherein the voting process comprises:
the first determination scheme voting for the transition times that it determines;
the second determination scheme voting for the transition times that it determines; and
determining the data symbol transition times as the transition times that receive the most votes.

9. A method according to claim 8, wherein the votes from the first determination scheme are given different weighting in the voting process than the votes from the second determination scheme.

10. A method according to claim 8, wherein the votes are added over a plurality of data symbol transitions to determine the data symbol transition times.

11. A method according to claim 1, further comprising evaluating the data symbols at times in between the determined data symbol transition times, to determine the value of the data symbols.

12. A receiver for receiving a serial data signal and determining data symbol transition times of the data signal, comprising:
a first determination device that determines data symbol transitions according to a first determination scheme;
a second determination device that determines data symbol transitions according to a second determination scheme; and
a voting processor for combining the results of the first and second determination schemes according to a voting process to determine the data symbol transition times.

13. The receiver of claim 12, wherein in both the first and second determination schemes the data symbol transitions are determined without prior determination of one of expected symbol edges and centres.

14. The receiver of claim 12, further comprising a sampler that samples the serial data signal and determines the data symbol values to which the samples correspond.

15. The receiver of claim 14, wherein the first determination device comprises an exclusive OR gate, the exclusive OR gate for receiving serial data signal samples that are adjacent to one another in time and that correspond to data symbol values of logic 1 or logic 0.

16. The receiver of claim 14, wherein the first determination device comprises a first AND gate for detecting a first series of samples that all correspond to data symbol values of logic 1, a second AND gate with inverting inputs for detecting a second series of samples that all correspond to data symbol values of logic 0, and a third AND gate for receiving the outputs of the first and second AND gates, and for indicating when a data symbol transition has occurred.

17. An integrated circuit comprising the receiver of claim 12.
